(19) United States
(12) Patent Application Publication
(10) Pub. No.: US 2009/0031983 A1
(43) Pub. Date: Feb. 5, 2009

(54) Air Filter for an Air Intake System of a Multi-Cylinder Internal Combustion Engine

(75) Inventors: Thomas Rauner, Blaubeuren (DE); Bjorn Muller, Altenstadt (DE); Rico Fischer, Vaihingen/Enz (DE); Erwin Rutschmann, Tiefenbronn (DE)

Correspondence Address: LERNER GREENBERG STEMER LLP, P O BOX 2480, HOLLYWOOD, FL, 33022-2480, US

(73) Assignee: Dr. Ing. h.c. F. Porsche AG, Weissach (DE)

(21) Appl. No.: 12/178,970

(22) Filed: Jul. 24, 2008

(30) Foreign Application Priority Data
Jul. 24, 2007 (DE) 10 2007 034 518.8

(51) Int. Cl. F02M 35/02; B01D 35/30

(52) U.S. Cl. 123/198 E; 55/419

(57) ABSTRACT

An air filter for an air intake system of a multi-cylinder internal combustion engine has a housing with a first housing part and a second housing part. A filter element is arranged between the housing parts. An untreated air side of the air filter is formed in the first housing part and a clean air side of the air filter is formed in the second housing part. The first housing part has a housing opening for conducting untreated air into the housing and the second housing part has a housing opening for discharging clean air out of the housing. Further, the housing has a third housing opening for conducting untreated air into the housing, with the housing holding a switchable flap arrangement for opening and closing the third housing opening. The flap arrangement can be activated as a function of operating states of the internal combustion engine. This allows variable, in particular large air masses to be passed through an air filter on account of the further housing opening.

### CROSS-REFERENCE TO RELATED APPLICATION

This application claims the priority, under 35 U.S.C. § 119, of German application DE 10 2007 034 518.8, filed Jul. 24, 2007; the prior application is herewith incorporated by reference in its entirety.

### BACKGROUND OF THE INVENTION

### Field of the Invention

The invention relates to an air filter for an air intake system of a multi-cylinder internal combustion engine, having a housing which has a first housing part and a second housing part, and having a filter element which is arranged between the housing parts. The untreated air side of the filter is formed in the first housing part and the clean air side of the air filter is formed in the second housing part. The first housing part also has a (first) housing opening for conducting untreated air into the housing and the second housing part has a (second) housing opening for discharging clean air out of the housing.

Air filters of that type for air intake systems of multi-cylinder internal combustion engines are well known from practice. In said air intake systems, untreated air is supplied to the air filter through a housing opening. An air filter which is connected to an intake pipe stub for supplying the untreated air and to an intake line for discharging clean air is known from the commonly assigned German published patent application DE 34 08 899 A1 and its counterpart U.S. Pat. No. 4,641,610. The clean air is supplied to an air intake system of a multi-cylinder internal combustion engine, with the volumes and lengths of the air intake system being tuned to the internal combustion engine so as to generate a good charging effect by means of ram charging over a large rotational speed range of the engine.

German patent DE 37 36 777 C1 describes a device for preventing the inlet of water into an air filter housing which is arranged in a fresh air line of an internal combustion engine. Arranged in the fresh air intake line, in each case at the untreated air side, is a water sensor and, in the region of an engine bay intake line which opens out into the fresh air intake line, a switchover valve. Also provided is a switching unit, which can be activated by means of control electronics in the event of water being detected by the water sensor, to adjust the switchover valve to engine bay induction. The device prevents the inlet of water into the air filter housing and therefore into the combustion chamber of the internal combustion engine. Permanent operating functionality is therefore ensured not only in the event of flowing rain but also in the event of relatively large quantities of water falling. The supply of untreated air to the air filter takes place via a single housing opening of the air filter.

German published patent application DE 100 53 145 A1 describes an intake system of an internal combustion engine in which a main untreated air inlet, which opens out into an air filter, can be closed off by way of a flap. An auxiliary untreated air inlet opens out into the main untreated air inlet downstream of the flap. If water or snow infiltrates into the intake system, the main untreated air inlet is closed off by the flap. Air is then aspirated in via the auxiliary untreated air inlet at a point which is protected from snow and water. In this arrangement, too, the filter housing has only a single housing opening for conducting untreated air into the housing.

### SUMMARY OF THE INVENTION

It is accordingly an object of the invention to provide an air filter for an air intake system of a multi-cylinder internal combustion engine which overcomes the above-mentioned disadvantages of the heretofore-known devices and methods of this general type and which enables variable, in particular large, air masses to be passed through the air filter.

With the foregoing and other objects in view there is provided, in accordance with the invention, an air filter for an air intake system of a multi-cylinder internal combustion engine. The novel assembly comprises:

a housing formed with a first housing part and a second housing part;

a filter element disposed between the first housing part and the second housing part, wherein an untreated air side of the air filter is formed in the first housing part and a clean air side of the air filter is formed in the second housing part;

the first housing part having a first housing opening formed therein for conducting untreated air into the housing;

the second housing part having a second housing opening formed therein for discharging cleaned air out of the housing;

the housing having a third housing opening formed therein for conducting untreated air into the housing; and

a switchable flap arrangement mounted to the housing for selectively opening and closing the third housing opening, and to be activated in dependence on an operating state of the internal combustion engine.

In other words, the objects of the invention are achieved with an air filter of the type specified in the introduction that is formed with a housing that has a further (third) housing opening for conducting untreated air into the housing. The housing holds a switchable flap arrangement for opening and closing the third housing opening. It is possible for the flap arrangement to be activated as a function of operating states of the internal combustion engine.

The supply of untreated air to the housing therefore takes place not via a single housing opening but rather via the housing opening and a further housing opening—first and third housing opening. Since two housing openings are available for conducting the untreated air into the air filter, and the third housing opening also has a switchable flap arrangement for opening and closing the housing opening, it is possible to set an air throughput through the housing as a function of operating states of the internal combustion engine. The flap arrangement is integrated directly into the housing of the air filter.

The activation of the flap arrangement for opening the third housing opening takes place according to free switching points, for example when cool air is to be expected in the engine bay in which the air filter is arranged. Advantageous here is the shortening of the intake path and therefore the reduction of throttling losses, because intake air/untreated air need not be supplied to the housing over a relatively long path via the first housing opening, which is generally connected to an intake line.

According to a further advantageous embodiment of the invention, it is provided that the second housing part has a further (fourth) housing opening for conducting in clean air from a further air filter. Said variant is used when an increased air mass throughput is necessary in a relatively high rotational speed range of the internal combustion engine, in which high power of the internal combustion engine is required, and accordingly a supply of air expediently takes place through two air filters. In this case, therefore, clean air is supplied from the one air filter through the fourth housing opening to the air filter according to the invention, and untreated air passes through the third housing opening, which has the switchable flap arrangement, of said air filter into the air filter housing, with the clean air from said air filter being discharged together with the supplied clean air from the other air filter out of the second housing part of the air filter according to the invention.

The flap arrangement of the air filter can be activated as a function of different operating states of the internal combustion engine. Operating states of the internal combustion engine are preferably its rotational speed, in particular a high rotational speed of the internal combustion engine, and/or its power, in particular a high power of the internal combustion engine, and/or its intake air temperature, in particular a low intake air temperature.

It is considered to be advantageous if the air filter is arranged in the engine bay of the vehicle, in particular of a passenger motor vehicle. For example, the first housing opening for conducting untreated air into the housing, or an end, which faces away from the air filter, of an intake line which is connected to the first housing opening, is arranged in a region of the engine bay of a vehicle which is protected during driving operation from water which infiltrates into the engine bay when it is raining.

On the other hand, it is considered to be advantageous, from the aspect of supplying a large air mass flow to the internal combustion engine as a function of the operating state of the internal combustion engine, if the flap arrangement of the air filter is arranged in a region of the vehicle which is impinged on by relative wind during driving operation.

With regard to the physical design of the flap arrangement, it is considered to be expedient if said flap arrangement has a plurality of flaps, in particular a plurality of flaps which can be adjusted together. The flaps are for example arranged parallel and can be actuated by means of a linkage. To switch the flap arrangement, a drive is provided, with the drive in particular having a pressure capsule which can be activated by means of a vacuum.

Further features of the invention can be gathered from the subclaims, from the following description of the drawing and from the drawing itself.

Other features which are considered as characteristic for the invention are set forth in the appended claims.

Although the invention is illustrated and described herein as embodied in air filter for an air intake system of a multi-cylinder internal combustion engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of the air filter according to the invention, in a first functional position of the air filter;

FIG. 2 is a similar view, showing the air filter in a second functional position;

FIG. 3 is a schematic view of the configuration of the air filter of FIGS. 1 and 2, and an air intake system for a multi-cylinder internal combustion engine;

FIG. 4 is a perspective view of the air intake system shown in FIG. 3;

FIG. 5 is a perspective view of the air intake system shown in FIG. 4, with upper sections of the collecting chambers removed; and

FIG. 6 is a perspective view, from below, of the upper sections of the collecting chamber and of an overflow chamber device which connects the upper sections.

### DETAILED DESCRIPTION OF THE INVENTION

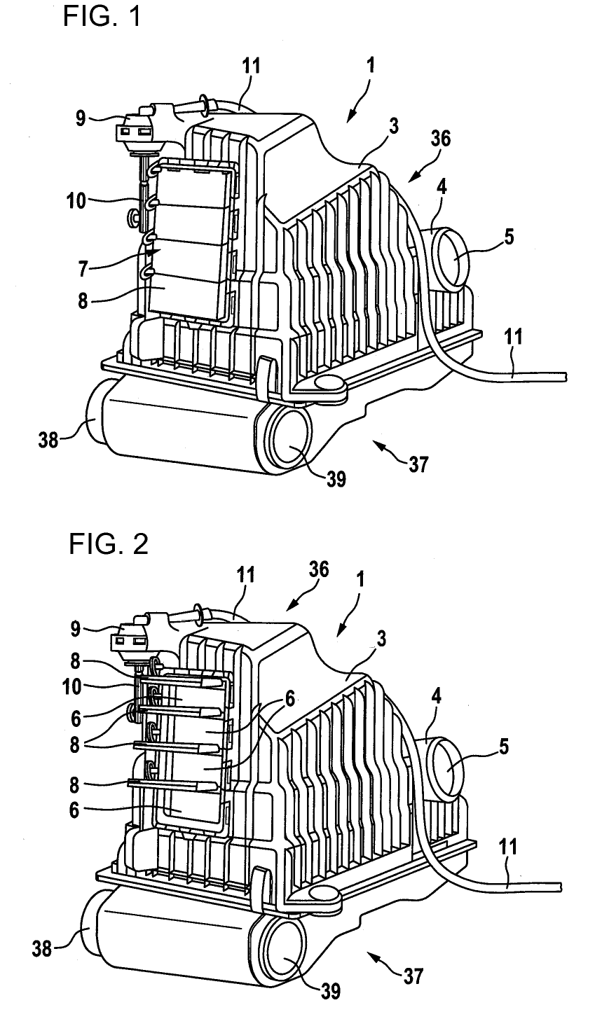

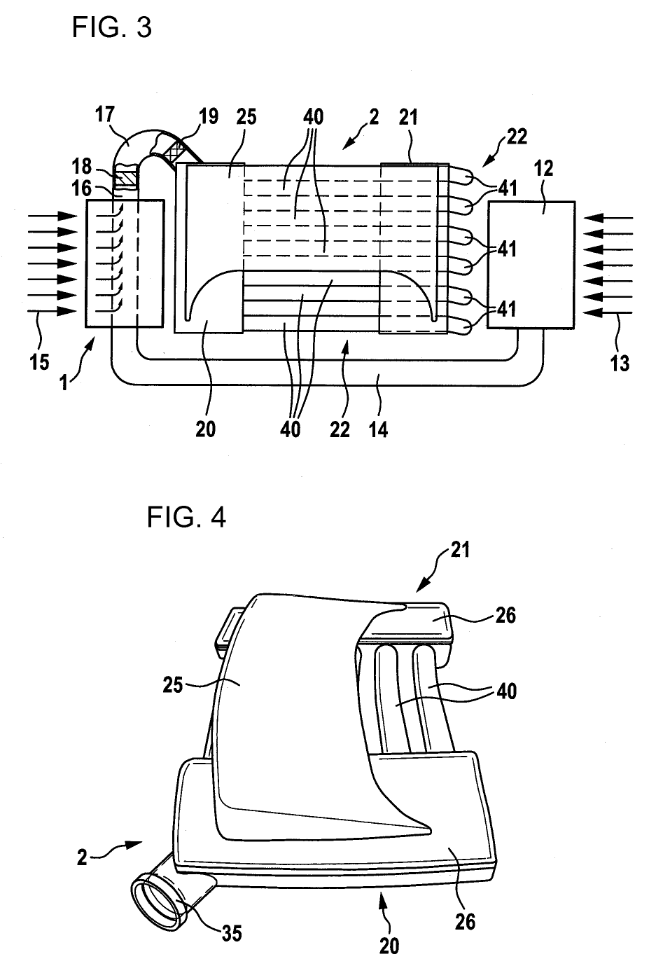

The air filter 1 according to the invention, as illustrated in FIGS. 1 and 2, is used for example for the air intake system 2, shown in FIGS. 3 to 6, of a multi-cylinder internal combustion engine. The internal combustion engine, by way of example, is an internal combustion engine with six cylinders.

Referring now to the figures of the drawing in detail and first, particularly, to FIGS. 1 and 2 thereof, the air filter 1 has a housing 3 with a first housing part 36 and a second housing part 37. A filter element (not visible) is disposed between the housing parts 36, 37. The untreated air side of the air filter 1 is formed in the first housing part 36 and the clean air side of the air filter 1 is formed in the second housing part 37.

The description and the claims use the terms “untreated air” and “clean air.” These terms, of course, should not be taken literally, but only in the context of the filter as being yet untreated or already treated by the filter of the novel assembly.

The inlet of the untreated air into the housing part 36 takes place via an intake pipe that connects to a connecting pipe stub 4 of the housing part 36. The connecting pipe stub 4 forms a first housing opening 5. In order to be able to pass variable, in particular large, air masses through the housing part 36, the housing part 36 is provided with a further housing opening, referred to below as the third housing opening 6. Said housing opening 6 can be opened and closed by means of a switchable flap arrangement 7. In the exemplary embodiment, the flap arrangement 7 has four flaps 8, with the respective flap 8 being pivotably mounted in the housing 3. The actuation of the flaps 8 of the flap arrangement 7 takes place by means of a pressure capsule 9 which can be activated by means of a vacuum and which switches the flaps 8 together by means of a switching rod 10. The vacuum line which leads to the pressure capsule 9 is denoted by the reference symbol 11. FIG. 1 shows the flaps 8 in their closed position, while FIG. 2 shows the flaps in their open position in which they therefore open the housing opening 6.

The flap arrangement 7 can be activated as a function of operating states of the internal combustion engine. Said operating states of the internal combustion engine are for example its rotational speed, in particular a high rotational speed of the internal combustion engine, and/or its power, in particular a high power of the internal combustion engine, and/or its intake air temperature, in particular a low intake air temperature. In said operating states, the flap arrangement 7 is activated in such a way that the flaps 8 open the housing opening 6.

Switching points of the flap arrangement are controlled by means of an electrical controller of the internal combustion engine.

The housing part 37 which is traversed by clean air has a housing opening—referred to as the second housing opening 38—through which the clean air flows out of the housing part 37. Furthermore, the housing part 37 is provided, on its side facing away from the housing opening 38, with a further housing opening—referred to as the fourth housing opening 39. Through said fourth housing opening 39, clean air discharged from a further air filter is supplied to the housing part 37.

FIG. 3 shows the arrangement of the air filter 1 and of the air intake system 2 which interacts with said air filter 1. Illustrated in a plan view is the arrangement of the relevant parts in the engine bay of the passenger motor vehicle, wherein in the direction of travel of the passenger motor vehicle, at the right-hand side, the air filter 1 is arranged adjacent to the air intake system 2, and the further air filter 12 is arranged adjacent to the air intake system 2 at the left-hand side. The arrows 13 depict the inlet of the untreated air into the air filter 12. The clean air from said air filter 12 is discharged through the inflow line 14, which is conducted in front of the air intake system 2, to the air filter 1. In physical terms, said inflow line 14 is connected to the connecting pipe stub 4 of the air filter 1. The untreated air, which flows in through the housing opening 6 of the air filter 1 when the flaps 8 are in the open position and through the housing opening 5 into the housing part 36 of the air filter 1, is denoted by the arrows 15. The clean air which has passed through the filter element of the filter 1 and the clean air which is supplied through the inflow line 14 from the filter 12 leaves the air filter 1 in the region of the connecting pipe stub 16 shown in FIG. 3, which connecting pipe stub 16 has the housing opening 38, with the inflow line 17 which is connected to said connecting pipe stub 16, as viewed in the flow direction of the intake air, firstly holding a measuring device 18 which determines the air mass flow which is sucked in through the inflow line 17, with said measuring device being embodied for example as a hot film mass sensor. Downstream of the measuring device 18, the inflow line 17 holds a throttle device which is embodied in particular as a throttle flap 19. Said throttle flap 19 is integrated into a connecting pipe stub 35 of the air intake system 2.

The air filter 1 according to the invention, in particular in connection with the further air filter 12, is used in a particular air intake system 2 of a passenger motor vehicle, in which the air mass throughput to the cylinders of the internal combustion engine is increased in the power position of the internal combustion engine. In this respect, reference is made to the following description of FIGS. 3 to 6:

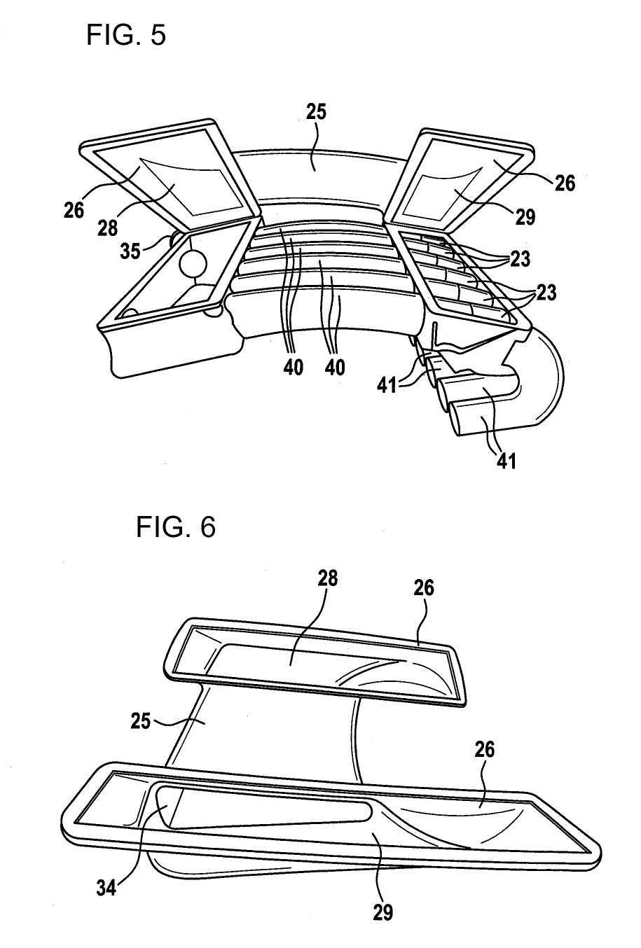

The air intake system 2 has a first collecting chamber 20 and a second collecting chamber 21 which are arranged parallel to one another and in the longitudinal direction of the vehicle. Via the inflow line 17, the intake air is supplied, on that side of the collecting chamber 20 which faces toward the air filter 1, into the collecting chamber 20 obliquely from the rear through the connecting pipe stub 35 when the throttle flap is in the open position. The air intake system 2 has six ram pipes 22. Each ram pipe 22 is formed by a first region 40, which is connected to the first collecting chamber 20 and is guided in a sealed fashion into the second collecting chamber 21 and is guided through said second collecting chamber 21, and by a second region 41. The second region 41 of the respective ram pipe 22 is arranged outside of and is connected to the second collecting chamber 21; said second region 41 preferably forms a part of the inlet duct of the cylinder. Within the second collecting chamber 21, the first regions 40 have sections 23 which are adjustable in their longitudinal direction. When the adjustable sections 23 are in a first position, as shown in FIG. 5, intake air is sucked directly through the first regions 40 of the ram pipes 22 into the second regions 41 of the ram pipes 22 and therefore into the cylinders of the internal combustion engine. When the adjustable sections 23 are in a second position (not shown) in which the adjustable sections 23 are adjusted in the direction of the first collecting chamber 20 and are therefore no longer connected to the second regions 41, intake air is sucked into the cylinders of the internal combustion engine via the then shortened ram pipes 22, and therefore only through the second regions 41.

The air intake system 2 also has an overflow chamber device 25 which is arranged above the first regions 40 of the ram pipes 22 and which connects the two collecting chambers 20 and 21 to one another in terms of flow. The alignment of the overflow chamber device 25 is in the transverse direction of the vehicle, corresponding to the alignment of the ram pipes 22.

In detail, the first collecting chamber 20 and the second collecting chamber 21 have upper, cover-like sections 26. The collecting chambers 20 and 21 and the overflow chamber device 25 are formed as a single-piece plastic molded part. Purely for greater clarity, FIGS. 5 and 6 illustrate the upper sections 26 and the overflow chamber device 25 as a separate unit. The air inlet opening of the overflow chamber device 25 is denoted by the reference symbol 28, and the air outlet opening of the overflow chamber device 25 is denoted by the reference symbol 29.

On account of the described design of the air intake system 2, the first collecting chamber 20 performs the function of a torque collecting chamber, and the second collecting chamber 21 performs the function of a power collecting chamber. When the adjustable sections 23 are in the first position, the ram pipes 22 suck in only the intake air which is then supplied directly to the cylinders of the internal combustion engine. In contrast, in the power position of the internal combustion engine, in which the adjustable sections 23 of the ram pipes 22 are in their second position, the cylinders can suck directly from the overall volume of the second collecting chamber 21 via the second regions 41 of the ram pipes 22, wherein on account of the special design of the air intake system 2 with the additional overflow chamber device 25, intake air passes into said collecting chamber 21 not only through the first regions 40 of the ram pipes 22 but also via the overflow chamber device 25. On account of the extremely large cross section of the overflow chamber device 25, in the power position of the internal combustion engine, the intake air is sucked in part via the overflow chamber device 25 from the first collecting chamber 20 into the second collecting chamber 21. An additional overflow volume between the torque collecting tank and the power collecting tank is therefore made available for an increased air mass throughput in the power position. The two air filters 1 and 12 ensure that said increased air mass throughput can be provided to the first collecting chamber 20.

In said operating state of the internal combustion engine, therefore at high power of the internal combustion engine, the flap arrangement 7 of the air filter 1 is activated such that the housing opening 6 is opened and additional intake air is supplied via said housing opening 6 to the inflow line 17. The introduction of the untreated air into the air filter 1 in the direct vicinity of the collecting chamber 20 results in a short intake path and, as a result, reduces the induction-related throttling losses.

That side of the air filter 12 through which the untreated air is sucked in the direction of the arrows 13 in the illustration is preferably arranged in a region which is aligned toward the engine region. The region is generally protected during driving operation from water which infiltrates into the engine bay when it is raining. The flap arrangement 7 can by all means be arranged in a region of the engine bay which is not protected in this way during driving operation from water which infiltrates into the engine bay when it is raining. If a sensor detects that there is the risk of infiltration of water into the air filter 1, the flaps 8 are moved into their closed position. The flap arrangement 7 is in particular arranged in a region of the vehicle which is impinged on by relative wind during driving operation.

1. An air filter for an air intake system of a multi-cylinder internal combustion engine, comprising:
a housing formed with a first housing part and a second housing part;
a filter element disposed between said first housing part and said second housing part, wherein an untreated air side of the air filter is formed in said first housing part and a clean air side of the air filter is formed in said second housing part;
said first housing part having a first housing opening formed therein for conducting untreated air into said housing;
said second housing part having a second housing opening formed therein for discharging cleaned air out of said housing;
said housing having a third housing opening formed therein for conducting untreated air into said housing; and
a switchable flap arrangement mounted to said housing for selectively opening and closing said third housing opening, and to be activated in dependence on an operating state of the internal combustion engine.

2. The air filter according to claim 1, wherein said second housing part is formed with a fourth housing opening for conducting in clean air from a further air filter.

3. The air filter according to claim 1, wherein the operating state of the internal combustion engine is selected from the group consisting of a rotational speed of the engine, and/or a power of the engine, and/or an intake air temperature into the engine.

4. The air filter according to claim 3, wherein said switchable flap arrangement is activated if a speed of the engine is relatively high, and/or if a power of the engine is relatively high, and/or if an intake air temperature is relatively low.

5. The air filter according to claim 1, wherein said flap arrangement of said air filter is mounted in a region of a motor vehicle that is impinged on by relative wind during a driving operation.

6. The air filter according to claim 1, wherein said first housing opening for conducting untreated air into said housing, or an end facing away from the air filter, of an intake line connected to said first housing opening, is disposed in a region of an engine bay of a motor vehicle that is protected during a driving operation from water infiltrating the engine bay during wet conditions.

7. The air filter according to claim 1, wherein said flap arrangement includes a plurality of flaps.

8. The air filter according to claim 7, wherein said plurality of flaps are configured to be adjusted together.

9. The air filter according to claim 1, which comprises a drive disposed to switch said flap arrangement, said drive having a pressure capsule to be activated by way of a vacuum.

10. The air filter according to claim 1, wherein switching points of said flap arrangement are controlled by way of an electrical controller of the internal combustion engine.
